(19) United States
(12) Patent Application Publication
(10) Pub. No.: US 2026/0149329 A1
(43) Pub. Date: May 28, 2026

(54) ROTATING MACHINE

(71) Applicant: MITSUBISHI ELECTRIC CORPORATION, Tokyo (JP)

(72) Inventors: Masahito MIYOSHI, Tokyo (JP); Yuichiro NAKAMURA, Tokyo (JP); Haruyuki HASEGAWA, Tokyo (JP); Kenta MOTOYOSHI, Tokyo (JP)

(73) Assignee: MITSUBISHI ELECTRIC CORPORATION, Tokyo (JP)

(21) Appl. No.: 19/491,411

(22) PCT Filed: Dec. 15, 2023
(86) PCT No.: PCT/JP2023/045095

§ 371 Date: Dec. 9, 2025

(51) Int. Cl. H02K 5/04; H02K 1/22; H02K 3/04

(52) U.S. Cl. CPC H02K 5/04; H02K 1/22; H02K 3/04

(57) ABSTRACT

A rotating machine includes a rotor rotating about a rotation axis, a stator disposed on outer or inner periphery of the rotor with a gap between the stator and the rotor, and a support member disposed on at least one side of the rotor in an axial direction, to support the rotor to limit displacements of the rotor in the axial direction and a tilt direction. At least one of the rotor or the stator includes an iron core and at least the other thereof includes a magnetic-force generating member. The iron core and the magnetic-force generating member are disposed such that the rotor displaced in the axial direction and the tilt direction is restored to an equilibrium position by force with which the stator magnetically attracts the rotor. The rotor is supported by the support member at a position displaced in the axial direction relative to the stator.

### FIELD

The present disclosure relates to a rotating machine in which a rotor is supported in a non-contact manner with respect to a stator.

### BACKGROUND

Rotating machines such as magnetic bearings and bearingless motors in which a rotor is supported in a non-contact manner with respect to a stator have been known. A magnetic bearing has a function to produce a supporting force to support a rotor in a non-contact manner with respect to a stator. A bearingless motor has a function as an electric motor to produce torque and a function as a magnetic bearing to produce a supporting force to support a rotor in a non-contact manner with respect to a stator on the same magnetic circuit. In order to support a rotor in a non-contact manner with respect to the stator, it is necessary to actively control all the five degrees of freedom except the rotation direction of the rotor about the rotation axis, or to provide a structure in which some of the five degrees of freedom except the rotation direction of the rotor about the rotation axis are passively stable without being actively controlled.

The five degrees of freedom mean one degree of freedom in an axial direction, two degrees of freedom in radial directions, and two degrees of freedom in tilt directions. The axial direction is a direction parallel to the rotation axis of the rotor (a direction along the Z axis). The radial directions are directions perpendicular to the rotation axis of the rotor, and include two directions that are a direction along the X axis perpendicular to the Z axis and a direction along the Y axis perpendicular to the Z axis and the X axis. The tilt directions are two directions that are a rotation direction about the X axis (ex) and a rotation direction about the Y axis (Oy). The phrase “passively stable” means that the rotor tries to return to a specific position without the position of the rotor being detected to control current values.

A two-degree-of-freedom controlled rotating machine typically detects, with sensors, the position of a rotor only in the two degrees of freedom in the radial directions (the direction along the X axis and the direction along the Y axis) of the five degrees of freedom described above, and adjusts a supporting force on the rotor in the radial direction so that the detected position coincides with a target position. That is, the two-degree-of-freedom controlled rotating machine performs active control only in the radial directions, and is provided with a passively stable structure for the three degrees of freedom in the axial direction and the tilt directions without active control thereof.

As a technique to provide a passively stable structure for the three degrees of freedom in the axial direction and the tilt directions, a technique is known which uses the force of attraction produced between permanent magnets of the rotor and an iron core of the stator. For example, Patent Literature 1 describes a technique in which, when a rotor is displaced from an ideal position in one degree of freedom in the axial direction, magnetic flux flowing between permanent magnets of the rotor and an iron core of a stator produces a force with which the stator magnetically attracts the rotor, and a restoring force to return the axially displaced rotor to the ideal position acts on the rotor. Further, Patent Literature 1 describes a technique in which, when the rotor tilts from the ideal position in two degrees of freedom in tilt directions, magnetic flux flowing between the permanent magnets of the rotor and the iron core of the stator produces a force with which the stator magnetically attracts the rotor, and a restoring torque to return the tilted rotor to the ideal position acts on the rotor. The restoring force increases in proportion to the displacement of the rotor in the axial direction. The restoring torque increases in proportion to the displacements of the rotor about the X axis and about the Y axis. Hereinafter, the displacement of the rotor in the axial direction, the displacement of the rotor about the X axis, and the displacement of the rotor about the Y axis are sometimes collectively referred to as the displacement of the rotor.

In any of the above-described cases, the rotor moves to an aligned state at the ideal position. As a result, for the three degrees of freedom in the axial direction and the tilt directions, the stiffness of the rotor can be secured by the magnetic flux generated from the permanent magnets. By thus providing the rotor with positive stiffness in the axial direction and the tilt directions, it is possible to provide a passively stable structure for the three degrees of freedom in the axial direction and the tilt directions.

### CITATION LIST

### Patent Literature

Patent Literature 1: Japanese Patent Application Laid-open No. 2005-121157

### SUMMARY OF INVENTION

### Problem to be Solved by the Invention

In the techniques disclosed in Patent Literature 1, the stability of the rotor in the axial direction and the tilt directions depends only on the restoring force and the restoring torque due to the magnetic flux generated from the permanent magnets. However, there is a problem that when the vibration of the rotor in the axial direction and the tilt directions occurs, only by the generation of the restoring force and the restoring torque proportional to the displacement of the rotor as in the techniques disclosed in Patent Literature 1, the vibration of the rotor cannot be prevented.

The present disclosure has been made in view of the above. It is an object of the present disclosure to provide a rotating machine that can prevent the vibration of a rotor in an axial direction and tilt directions with a passively stable structure for three degrees of freedom in the axial direction and the tilt directions of the rotor.

### Means to Solve the Problem

In order to solve the above-described problem and achieve the object, a rotating machine according to the present disclosure includes a rotor that rotates about a rotation axis, a stator disposed on the outer periphery or the inner periphery of the rotor with a gap between the stator and the rotor, and a support member disposed on at least one side of the rotor in an axial direction along the rotation axis, to support the rotor so as to limit displacements of the rotor in the axial direction and a tilt direction. At least one of the rotor or the stator includes an iron core. At least the other of the rotor or the stator includes a magnetic-force generating member. The iron core and the magnetic-force generating member are disposed such that the rotor displaced in the axial direction and the tilt direction is restored to an equilibrium position by a force with which the stator magnetically attracts the rotor. The rotor is supported by the support member at a position displaced in the axial direction relative to the stator.

### Effects of the Invention

The rotating machine according to the present disclosure has the effect of being able to prevent the vibration of the rotor in the axial direction and the tilt directions with a passively stable structure for three degrees of freedom in the axial direction and the tilt directions of the rotor.

### BRIEF DESCRIPTION OF DRAWINGS

FIG. 1 is a perspective view illustrating a configuration of a rotating machine according to a first embodiment.

FIG. 2 is a cross-sectional view illustrating the configuration of the rotating machine according to the first embodiment, and is a diagram for explaining a radial supporting force acting on a rotor.

FIG. 3 is a cross-sectional view illustrating the configuration of the rotating machine according to the first embodiment, and is a diagram for explaining an axial force acting on the rotor.

FIG. 4 is a cross-sectional view illustrating a configuration of a rotating machine according to a first modification of the first embodiment.

FIG. 5 is a cross-sectional view illustrating a configuration of a rotating machine according to a second modification of the first embodiment.

FIG. 6 is a perspective view illustrating a configuration of a rotating machine according to a second embodiment.

FIG. 7 is a cross-sectional view illustrating a configuration of a rotating machine according to a third embodiment.

FIG. 8 is a cross-sectional view illustrating a configuration of a rotating machine according to a modification of the third embodiment.

FIG. 9 is a perspective view illustrating a configuration of a support member of a rotating machine according to a fourth embodiment.

FIG. 10 is a diagram illustrating a configuration of a rotor of a rotating machine according to a modification of the fourth embodiment when the rotor is viewed in an axial direction.

FIG. 11 is a perspective view illustrating a configuration of part of a stator core of a rotating machine according to a fifth embodiment.

FIG. 12 is a cross-sectional view illustrating a configuration of the rotating machine according to the fifth embodiment, and is a diagram for explaining an axial force acting on a rotor.

### DESCRIPTION OF EMBODIMENTS

Hereinafter, a rotating machine according to embodiments will be described in detail with reference to the drawings.

### First Embodiment

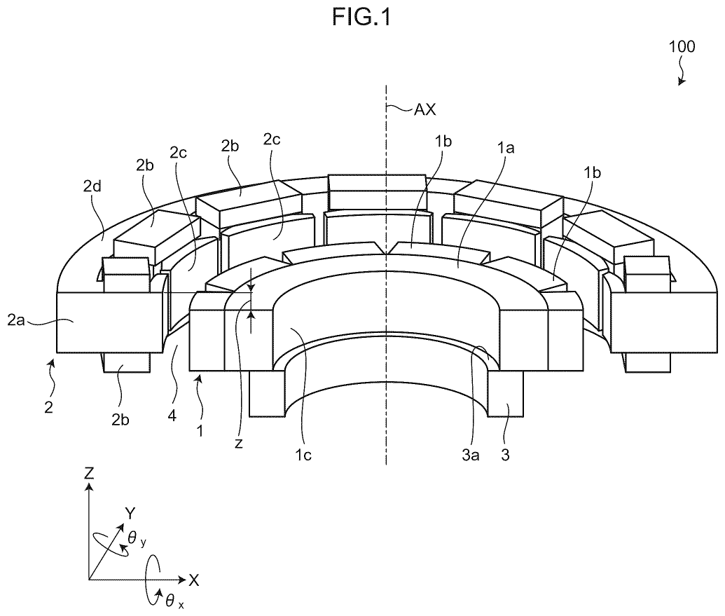

FIG. 1 is a perspective view illustrating a configuration of a rotating machine 100 according to a first embodiment. FIG. 1 illustrates a state in which the rotating machine 100 is cut in half along the axial direction to facilitate understanding. In FIG. 1, section hatching is omitted. As illustrated in FIG. 1, the rotating machine 100 includes a rotor 1, a stator 2, and a support member 3. Although not illustrated, the rotating machine 100 includes a frame that houses the rotor 1, the stator 2, and the support member 3, a shaft provided in the center of the rotor 1, and others. The rotor 1 rotates about a rotation axis AX relative to the stator 2.

Hereinafter, when directions are described for the components of the rotating machine 100, a direction parallel to the rotation axis AX is referred to as the axial direction, a direction perpendicular to the rotation axis AX as the radial direction, and a rotation direction about the rotation axis AX as the circumferential direction. The X axis, the Y axis, and the Z axis illustrated in the drawings are three axes perpendicular to each other. The Z axis is parallel to the rotation axis AX. A direction along the 2 axis (Z-axis direction) is parallel to the axial direction. The X axis and the Y axis are perpendicular to the rotation axis AX. A direction along the X-axis (X-axis direction) is a direction perpendicular to the axial direction and is a direction included in the radial direction. A direction along the Y axis (Y-axis direction) is a direction perpendicular to the axial direction and is a direction included in the radial direction. Hereinafter, the X-axis direction and the Y-axis direction are collectively referred to as the XY axis direction when not distinguished from each other. The rotation direction about the X axis θₓ and the rotation direction about the Y axis θ_{y} are collectively referred to as the tilt direction when not distinguished from each other. Of each axis, the direction of an arrow is referred to as a positive direction, and a direction opposite to the direction of the arrow as a negative direction. The present embodiment illustrates a case where a direction along the rotation axis AX is parallel to a vertical direction. In the present embodiment, the positive direction of the Z axis is a vertically upward direction, and the negative direction of the Z axis is a vertically downward direction.

The rotor 1 rotates about the rotation axis AX. The rotor 1 includes a rotor core 1a and a plurality of permanent magnets 1b. The rotor core 1a has a cylindrical shape in the present embodiment. A through hole 1c extending in the axial direction is formed in the center of the rotor core 1a. The shaft (not illustrated) is disposed in the through hole 1c.

The plurality of permanent magnets 1b are disposed on the outer periphery of the rotor core 1a. The plurality of permanent magnets 1b are disposed at equal angles in the circumferential direction. The permanent magnets 1b that are magnetic-force generating members may be fixed to the rotor core 1a by magnetic forces, or may be fixed to the rotor core 1a with a fixing member such as an adhesive. The permanent magnets 1b are attached to the surface of the rotor core 1a in the present embodiment, but may be embedded in the rotor core 1a.

The stator 2 is disposed on the outer periphery of the rotor 1 with a gap 4 between the stator 2 and the rotor 1. The stator 2 includes a stator core 2a that is an iron core, and a plurality of windings 2b. The stator core 2a and the windings 2b constitute electromagnets that are magnetic-force generating members.

The stator core 2a has a cylindrical shape in the present embodiment. The stator core 2a includes a plurality of teeth 2c disposed side by side in the circumferential direction, and a back yoke 2d connecting the plurality of teeth 2c at outer peripheral portions of the teeth 2c. The plurality of teeth 2c are radially disposed around the rotation axis AX. The plurality of teeth 2c are disposed at equal angles in the circumferential direction. The back yoke 2d is formed in a cylindrical shape.

The windings 2b are wound around the respective teeth 2c. The windings 2b generate magnetic fields for rotating the rotor 1 in the circumferential direction.

The support member 3 is a member disposed on at least one side of the rotor 1 in the axial direction along the rotation axis AX, to support the rotor 1 so as to limit the displacement of the rotor 1 in the axial direction and the tilt directions. In the present embodiment, the axial direction along the rotation axis AX is parallel to the vertical direction, and the support member 3 is disposed below the rotor 1 in the vertical direction. The support member 3 has a cylindrical shape in the present embodiment, but is not limited to a particular shape as long as the support member 3 can support the rotor 1. The support member 3 has a hollow shape in the present embodiment, but may have a solid shape. The support member 3 is fixed to the frame (not illustrated). Although FIG. 1 illustrates a state in which the inner diameter of the support member 3 is smaller than the inner diameter of the rotor 1 in order to clarify the difference between the support member 3 and the rotor 1, the present invention is not limited to the illustrated example. The inner diameter of the support member 3 may be larger than the inner diameter of the rotor 1, or the inner diameter of the support member 3 may be the same as the inner diameter of the rotor 1.

The support member 3 includes a support surface 3a that supports the rotor 1. The support surface 3a is in circumferential contact with one side of the rotor 1 in the axial direction. The support member 3 includes a low-friction portion that reduces the frictional force between the support member 3 and the rotor 1. The material of the support member 3 may be a material having a lower friction coefficient than that of the rotor 1 so that the low-friction portion is formed on all or part of the support member 3 (a portion of the support member 3 that contacts the rotor 1), or a lubricant applied to the portion of the support member 3 that contacts the rotor 1 may constitute the low-friction portion. An example of the material having the lower friction coefficient is Teflon (registered trademark). An example of the lubricant is grease.

The rotor 1 is supported by the support member 3 at a position displaced in the axial direction relative to the stator 2. In the present embodiment, the rotor 1 is supported by the support member 3 at a position sunk downward in the vertical direction relative to the stator 2. The stator core 2a and the permanent magnets 1b are disposed such that the rotor 1 displaced in the axial direction and the tilt direction is restored to the equilibrium position by the force with which the stator 2 magnetically attracts the rotor 1. The rotor core 1a and the electromagnets are disposed such that the rotor 1 displaced in the axial direction and the tilt direction is restored to the equilibrium position by the force with which the stator 2 magnetically attracts the rotor 1. That is, even when magnetic flux produced by the permanent magnets 1b of the rotor 1 is replaced by magnetic flux produced by the electromagnets of the stator 2, a force to restore the rotor 1 displaced in the axial direction and the tilt direction to the equilibrium position acts on the rotor 1 likewise.

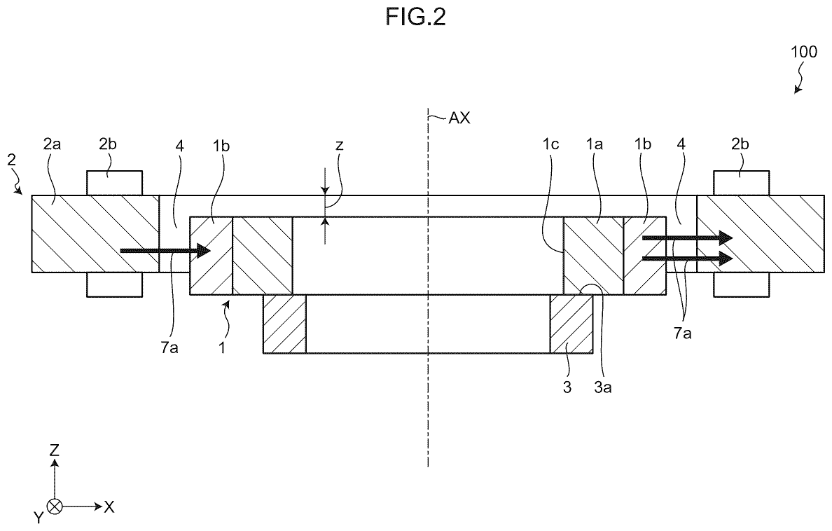

Here, with reference to FIG. 2, a supporting force acting on the rotor 1 in the radial direction (XY axis direction) will be described. FIG. 2 is a cross-sectional view illustrating the configuration of the rotating machine 100 according to the first embodiment, and is a diagram for explaining a radial supporting force acting on the rotor 1. Cross-sectional views including FIG. 2 are cross-sectional views taken along the axial direction. p is the number of poles when the N-pole permanent magnets 1b and the S-pole permanent magnets 1b are circumferentially alternately disposed on the surface of the rotor core 1a. When the windings 2b of the stator 2 are energized, that is, varying currents i are passed through the windings 2b of the stator 2, p-pole magnetic fields are produced. When the p-pole magnetic fields are rotated by changing the phases of the passed currents, the rotor 1 is also rotated by being attracted to the rotation of the p-pole magnetic fields. Consequently, torque is produced, allowing the control of the rotational speed and angle of the rotor 1. When p±2-pole magnetic fields are produced, an angle at which the density of magnetic flux 7a increases and an angle at which the density of the magnetic flux 7a decreases occur in the gap 4. Due to this difference in the density of the magnetic flux 7a, a supporting force in the radial direction (XY axis direction) is produced which is the force with which the rotor 1 is magnetically attracted to the stator 2 in the radial direction. Thus, the rotor 1 can be supported in a non-contact manner with respect to the stator 2.

In the case where the rotating machine 100 is a typical bearingless motor such as a surface permanent magnet bearingless motor, as described above, when p±2-pole magnetic fields are produced, an angle at which the density of the magnetic flux 7a increases and an angle at which the density of the magnetic flux 7a decreases occur in the gap 4, and a supporting force in the radial direction (XY axis direction) is generated. On the other hand, in the case where the rotating machine 100 is a consequent pole bearingless motor in which the permanent magnets 1b with only either the N-poles or the S-poles are attached between the salient poles of the rotor core 1a, or a homopolar bearingless motor that uses the salient-pole rotor core 1a and the permanent magnets 1b magnetized in the axial direction, or the like, when 2-pole magnetic fields are produced, an angle at which the density of the magnetic flux 7a increases and an angle at which the density of the magnetic flux 7a decreases occur in the gap 4, and a supporting force in the radial direction (XY axis direction) is generated.

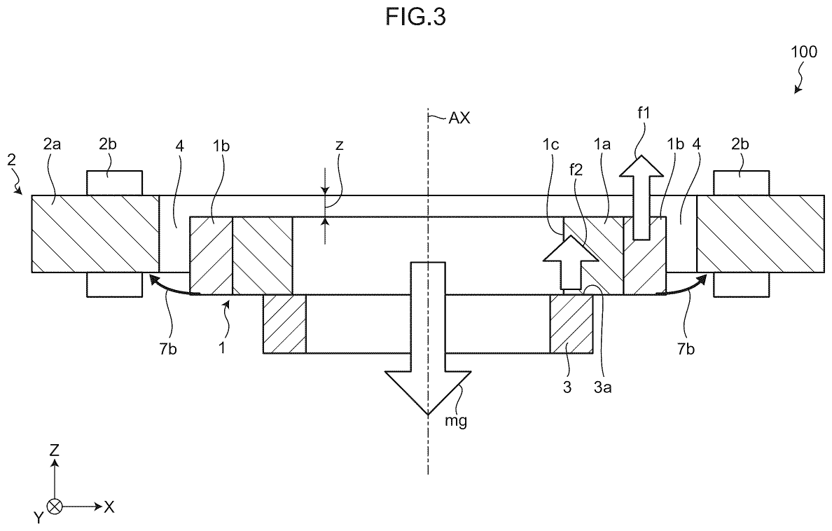

Next, with reference to FIG. 3, an axial force acting on the rotor 1 will be described. FIG. 3 is a cross-sectional view illustrating the configuration of the rotating machine 100 according to the first embodiment, and is a diagram for explaining the axial force acting on the rotor 1. FIG. 3 illustrates a case where the gravitational force mg acts on the rotor 1.

The rotor 1 is displaced downward in the vertical direction, that is, in the axial direction relative to the stator 2 by the gravitational force mg. Consequently, portions of the rotor 1 and the stator 2 do not face each other in the radial direction, and magnetic flux 7b obliquely passing between the rotor 1 and the stator 2 is generated. FIG. 3 illustrates the magnetic flux 7b that comes out of the rotor 1 and obliquely enters the lower surfaces of distal end portions of the teeth 2c of the stator 2 since the rotor 1 is displaced vertically downward relative to the stator 2. Here, z (z<0) is the axial displacement of the rotor 1 relative to the stator 2, and kz is the axial stiffness of the rotor 1.

When the rotor 1 is displaced in the axial direction relative to the stator 2, a restoring force f1 is produced in the direction opposite to the direction of the axial displacement z of the rotor 1. Specifically, the magnetic flux 7b obliquely passing between the rotor 1 and the stator 2 produces the restoring force f1 to return the rotor 1 to the magnetic center in the axial direction of the rotor 1, that is, to the position of z=0. The restoring force f1 increases in proportion to the axial displacement z of the rotor 1. f1=−kz×z, where kz is the axial stiffness of the rotor 1 as described above. The negative sign added to the axial stiffness kz of the rotor 1 means that the rotor 1 is attracted to the stator 2 in the direction opposite to the displacement direction of the rotor 1. The restoring force f1 is a magnetic force that supports the rotor 1 in the axial direction, and is a force to move the rotor 1 vertically upward in the illustrated example.

The rotor 1 is also supported by the support member 3 in the axial direction. A force with which the rotor 1 is supported by the support member 3 in the axial direction is referred to as a supporting force f2. The supporting force f2 is equal to the remaining component of the gravitational force mg left unsupported by the restoring force f1, and thus formula (1) below holds.

$$f 2 = mg - f 1 \qquad ( 1 )$$

On the other hand, assuming a case where the rotor 1 is not displaced in the axial direction relative to the stator 2, that is, z=0, the restoring force f1=0. At this time, formula (2) below holds.

$$f 2 = mg \qquad ( 2 )$$

Therefore, according to formulas (1) and (2) above, the restoring force f1 can be increased by setting the axial displacement z of the rotor 1 relative to the stator 2 to a negative value and increasing the absolute value thereof, that is, by increasing the amount of displacement of the rotor 1 in the direction of the gravitational force mg acting on the rotor 1 (in the negative direction of the z-axis direction). Consequently, most of the gravitational force mg can be supported by the restoring force f1, and the supporting force f2, which is the remaining component, can be reduced. The supporting force f2 is also a force with which the rotor 1 is supported by the support member 3 in the tilt direction. That is, the supporting force f2 is the force with which the rotor 1 is supported by the support member 3 in the axial direction and the tilt directions.

Although not illustrated, when the rotor 1 is displaced in the tilt direction relative to the stator 2, a restoring torque is produced in the direction opposite to the tilt direction of the displacement of the rotor 1. Specifically, the magnetic flux 7b passing obliquely between the rotor 1 and the stator 2 produces a restoring torque to return the rotor 1 to the magnetic center in the tilt direction. The restoring torque increases in proportion to the displacement of the rotor 1 in the tilt direction. The present embodiment can provide a passively stable structure for the three degrees of freedom in the axial direction and the tilt directions of the rotor 1 since the restoring force or the restoring torque with which the rotor 1 displaced in the axial direction and the tilt direction tries to return to the magnetic center in the axial direction and the tilt direction is produced in the gap 4 without the position of the rotor 1 being detected to control the current values. Since the torque and the supporting force in the radial direction, and the restoring force f1 and the restoring torque are produced in the gap 4, the rotating machine 100 can be reduced in size and weight, as compared with a case where a portion where the torque and the supporting force in the radial direction are produced is separate from a portion where the restoring force f1 and the restoring torque are produced.

Next, effects of the rotating machine 100 according to the present embodiment will be described.

In the present embodiment, as illustrated in FIG. 3, the stator core 2a and the permanent magnets 1b, which are the magnetic-force generating members, are disposed such that the rotor 1 displaced in the axial direction and the tilt direction is restored to the equilibrium position by the force with which the stator 2 magnetically attracts the rotor 1. In the present embodiment, the rotor core 1a and the electromagnets, which are the magnetic-force generating members, are disposed such that the rotor 1 displaced in the axial direction and the tilt direction is restored to the equilibrium position by the force with which the stator 2 magnetically attracts the rotor 1. In the present embodiment, the rotating machine 100 includes the support member 3 that is disposed on at least one side of the rotor 1 in the axial direction along the rotation axis AX, to support the rotor 1 so as to limit the displacement of the rotor 1 in the axial direction and the tilt directions. These configurations allow the rotor 1 to be supported in the axial direction and the tilt directions by the support member 3 in addition to the restoring force and the restoring torque produced in proportion to the displacement of the rotor 1. This prevents a further displacement of the rotor 1 in the axial direction and displacements of the rotor 1 in the tilt directions. Consequently, the vibration of the rotor 1 in the axial direction and the tilt directions can be prevented.

For example, when an impact is applied to the rotor 1 from the outside of the rotating machine 100, vibration generated in the rotor 1 can be prevented, and the duration of vibration generated in the rotor 1 can also be reduced. Even when there is a frequency at which vibration of the rotor 1 is likely to occur, which is determined by the stiffness of the rotor 1 and the mass and the moment of inertia of the rotor 1, and the value of this frequency matches the rotation speed of the rotor 1, a resonance phenomenon can be avoided to prevent vibration of the rotor 1. It has been required to pay attention to the rotation of the rotor 1 so as to avoid a resonance phenomenon. In the present embodiment, by using the support member 3, the rotor 1 can be rotated in a wide operating range without paying attention to avoiding a resonance phenomenon. As described above, the present embodiment can provide the rotating machine 100 that can prevent the vibration of the rotor 1 in the axial direction and the tilt directions with the passively stable structure for the three degrees of freedom in the axial direction and the tilt directions of the rotor 1.

In the present embodiment, as illustrated in FIG. 3, the rotor 1 is supported by the support member 3 at a position axially displaced relative to the stator 2. This configuration can increase the restoring force f1 and reduce the supporting force f2. For example, the ratio between the restoring force f1 and the supporting force f2 illustrated in FIG. 3 may be set, for example, to 9:1 or 19:1, to set the supporting force f2 to a value close to zero. By thus reducing the supporting force f2, frictional heat generated at the support member 3 during rotation of the rotor 1 is significantly reduced. Further, by reducing the supporting force f2, wear on the support member 3 is reduced, so that the frequency of replacing the support member 3 can be reduced to operate the rotating machine 100 for a long period of time. Furthermore, by reducing the supporting force f2, the loss of torque caused by physical contact between the rotor 1 and the support member 3 can be reduced to increase the operating efficiency of the entire rotating machine 100. This can prevent the vibration of the rotor 1 in the axial direction and the tilt directions while making the loss of torque and the operating efficiency of the entire rotating machine 100 substantially equal to those when the support member 3 is not provided.

In the present embodiment, as illustrated in FIG. 3, the support member 3 is in circumferential contact with the rotor 1. This configuration, in which the support member 3 supports the rotor 1 over the entire circumference of the rotor 1, further prevents a further displacement of the rotor 1 in the axial direction and displacements of the rotor 1 in the tilt directions.

In the present embodiment, the support member 3 illustrated in FIG. 3 includes the low-friction portion that reduces the frictional force between the support member 3 and the rotor 1. This configuration can reduce the frictional force generated between the rotor 1 and the support member 3 to achieve the same effects as the effects when the supporting force f2 is reduced as described in paragraph 0036 above.

There has been known a technique in which repulsive magnets functioning as a magnetic bearing are disposed on each of the stator and the rotor, and repulsive forces generated between the repulsive magnets are used to provide a passively stable structure for the three degrees of freedom in the axial direction and the tilt directions of the rotor. This conventional technique has a problem that repulsive performance depends on the magnetized state of the repulsive magnets, the mounting accuracy of the repulsive magnets, etc., a problem that the dimensions and cost are increased by the repulsive magnets, and a problem that performance degradation of the repulsive magnets, thermal demagnetization of the repulsive magnets, etc. occur due to an increase in temperature. In this regard, in the present embodiment, as illustrated in FIG. 3, the rotor 1 is supported by the support member 3 at the position displaced in the axial direction relative to the stator 2, and thus repulsive magnets are unnecessary. That is, in the present embodiment, the stator 2 generates a force to magnetically attract the rotor 1, allowing a passively stable structure for the three degrees of freedom in the axial direction and the tilt directions of the rotor 1, and thus repulsive magnets are unnecessary. Consequently, the present embodiment can prevent the occurrence of the above-described problems.

In the rotating machine 100 illustrated in FIG. 3, a method is conceivable in which the rotor 1 is repelled vertically downward relative to the stator 2, using repulsive magnets, and the sum of the gravitational force mg and the repulsive force is supported by the supporting force f2. However, with this method, the supporting force £2 becomes a force exceeding the gravitational force mg on the rotor 1. This causes problems that frictional heat generated at the support member 3 increases, wear on the support member 3 increases, the life of the support member 3 decreases, and the loss of torque increases. In this regard, the present embodiment, in which the restoring force f1 generated between the stator 2 and the rotor 1 allows the supporting force f2 to be smaller than the gravitational force mg on the rotor 1, can prevent the occurrence of the above-described problems.

Next, a modification of the first embodiment will be described.

As illustrated in FIG. 1, the present embodiment is the inner rotor rotating machine 100 in which the rotor 1 is disposed on the inner periphery of the stator 2, but may be the outer rotor rotating machine 100 in which the rotor 1 is disposed on the outer periphery of the stator 2.

In the present embodiment, as illustrated in FIG. 1, the rotation axis AX (Z axis) of the rotor 1 is parallel to the vertical direction. However, the entire rotating machine 100 may be tilted with respect to the vertical direction to have the angular difference between the rotation axis AX of the rotor 1 and the vertical direction. That is, the rotation axis AX of the rotor 1 may be tilted with respect to the vertical direction.

As illustrated in FIG. 3, the present embodiment has illustrated the case where, assuming the gravitational force mg acting on the rotor 1, part of the gravitational force mg acting on the rotor 1 is supported by the support member 3, but part of a force other than the gravitational force mg may also be supported by the support member 3. For example, a load such as a fan or a pump may be attached to the rotor 1. At this time, a reaction force when fluid is fed by the load such as a fan or a pump acts on the rotor 1. This causes the axial displacement z of the rotor 1 relative to the stator 2. Therefore, part of the reaction force acting on the rotor 1 may be supported by the support member 3. When the gravitational force mg and the reaction force act on the rotor 1, part of the gravitational force mg and the reaction force acting on the rotor 1 may be supported by the support member 3. Even when the axial direction of the rotor 1 is parallel to the horizontal direction, the reaction force is generated. That is, even when the rotation axis AX of the rotor 1 is parallel to the horizontal direction, the axial displacement z of the rotor 1 relative to the stator 2 may occur. Therefore, the rotation axis AX of the rotor 1 may be parallel to the horizontal direction. When the position of the stator 2 in the axial direction is used as a reference position, the support member 3 only needs to support the rotor 1 at a position where the rotor 1 is displaced from the reference position in the direction of the gravitational force mg acting on the rotor 1 or in the direction in which the reaction force acting on the rotor 1 during rotation is generated in the axial direction. This reduces the supporting force f2 generated at the support member 3 by the load borne by the restoring force f1 in the axial direction generated between the stator 2 and the rotor 1, as compared with the case where the rotor 1 is supported at the position not displaced in the axial direction from the reference position.

As illustrated in FIG. 1, the present embodiment has illustrated the case where the rotor 1 includes the permanent magnets 1b and the stator 2 includes the stator core 2a as the iron core, but the rotor 1 may include an iron core and the stator 2 may include permanent magnets. That is, in the case where permanent magnets are disposed on the magnetic circuit so that the rotor 1 displaced in the axial direction and the tilt direction is restored to the equilibrium position by the force with which the stator 2 magnetically attracts the rotor 1, it is sufficient that at least one of the rotor 1 or the stator 2 includes an iron core, and at least the other of the rotor 1 or the stator 2 includes permanent magnets.

The present embodiment is the rotating machine 100 with the permanent magnets 1b provided on the rotor 1, but may be the rotating machine 100 without the permanent magnets 1b provided on the rotor 1. For example, by forming salient poles or slits on or in the rotor core 1a, the rotating machine 100 may be changed to a synchronous reluctance motor in which reluctance, which is the resistance to the passage of magnetic flux, varies according to the rotation angle of the rotor 1.

In the present embodiment, as illustrated in FIG. 1, the shape of the rotor 1 is hollow, but may be solid. In the case where the shape of the rotor 1 is hollow, the hollow space may be used, for example, as a path through which wiring is passed or a fluid flow path. The hollow shape of the rotor 1 allows a reduction in the weight of the entire rotating machine 100. When the rotor 1 generates heat, the hollow shape of the rotor 1 allows the heat to be released to the hollow space to increase the cooling effect of the rotor 1.

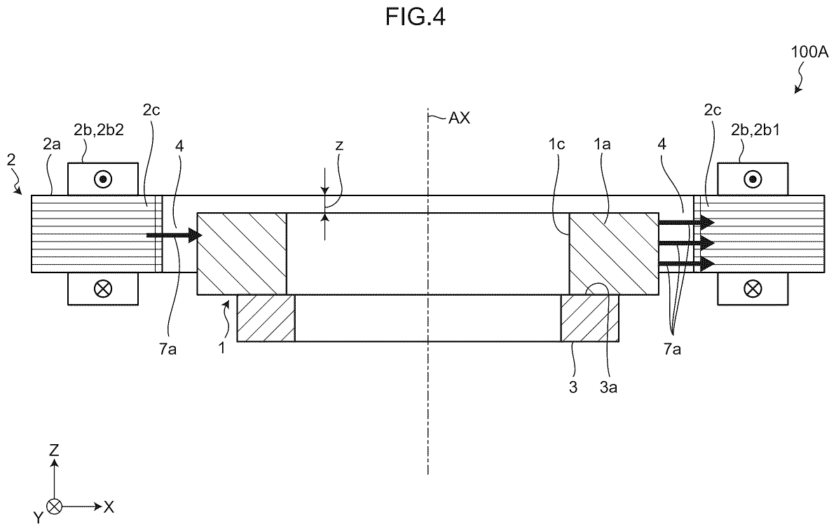

As illustrated in FIG. 2, the present embodiment has illustrated the configuration in which by disposing the permanent magnets 1b on the magnetic circuit in addition to passing the varying currents i contributing to an increase and a decrease in the supporting force in the radial direction (XY axis direction) through the windings 2b, the supporting force in the radial direction (XY axis direction) acting on the rotor 1 is generated, but the present invention is not limited thereto. For example, as illustrated in FIG. 4, by passing bias currents I through the windings 2b in addition to passing the varying currents i contributing to an increase and a decrease in the supporting force in the radial direction (XY axis direction) through the windings 2b, the supporting force in the radial direction (XY axis direction) acting on the rotor 1 may be generated. FIG. 4 is a cross-sectional view illustrating a configuration of a rotating machine 100A according to a first modification of the first embodiment.

The rotor 1 illustrated in FIG. 4 includes only the rotor core 1a and does not include the permanent magnets 1b. There are no differences in reluctance in the rotor 1. The stator core 2a and the windings 2b constitute electromagnets. Here, a case where a supporting force in the X-axis direction is generated will be described. A winding 2b1 is wound around one of the teeth 2c located in the positive direction of the X-axis direction. A winding 2b2 is wound around one of the teeth 2c located in the negative direction of the X-axis direction. A current of I+i (A: ampere) that is the sum of the bias current I and the varying current i is passed through the winding 2b1. A current of I−i (A: ampere) that is the difference between the bias current I and the varying current i is passed through the winding 2b2. At this time, the density of the magnetic flux 7a can be increased and decreased in the gap 4.

Considering the fact that the current is proportional to the density of the magnetic flux 7a and the fact that the force is proportional to the square of the density of the magnetic flux 7a, the force acting on the surface of the rotor 1 facing the gap 4 located in the positive direction of the X-axis direction is k(I+i)², where k is a constant, and the force acting on the surface of the rotor 1 facing the gap 4 located in the negative direction of the X-axis direction is k(I−i)². The difference between the two forces is 4×k×I×i. Consequently, the rotor 1 receives a force of 4×k×I×i in the positive direction of the X-axis direction. That is, by adjusting the varying currents i passed through the windings 2b1 and 2b2 after passing the bias currents I through the windings 2b1 and 2b2, a supporting force in the X-axis direction proportional to the magnitude of the varying currents i can be generated. In the case where it is desired to generate a supporting force also in the Y-axis direction, the varying currents i to be passed through other windings 2b can be adjusted as in the case of generating the supporting force in the X-axis direction. Consequently, the rotating machine 100A functions as a magnetic bearing that generates a supporting force in the radial direction (XY axis direction).

In the present modification, the rotor core 1a and the electromagnets as the magnetic-force generating members are disposed such that the rotor 1 displaced in the axial direction and the tilt direction is restored to the equilibrium position by the force with which the stator 2 magnetically attracts the rotor 1. With this configuration, like the first embodiment, the present modification can also provide a passively stable structure for the three degrees of freedom in the axial direction and the tilt directions of the rotor 1 since the restoring force or the restoring torque with which the rotor 1 displaced in the axial direction and the tilt direction tries to return to the magnetic center in the axial direction and the tilt direction is produced without the position of the rotor 1 being detected to control the current values. The present modification, like the first embodiment, can also prevent the vibration of the rotor 1 in the axial direction and the tilt directions with the support member 3. It is sufficient that at least one of the rotor 1 or the stator 2 includes the iron core, and at least the other of the rotor 1 or the stator 2 includes the magnetic-force generating members. The rotor 1 may include both the permanent magnets 1b and the electromagnets as the magnetic-force generating members. In this configuration, the electromagnets consist, for example, of the rotor core 1a and windings wound around the rotor core 1a.

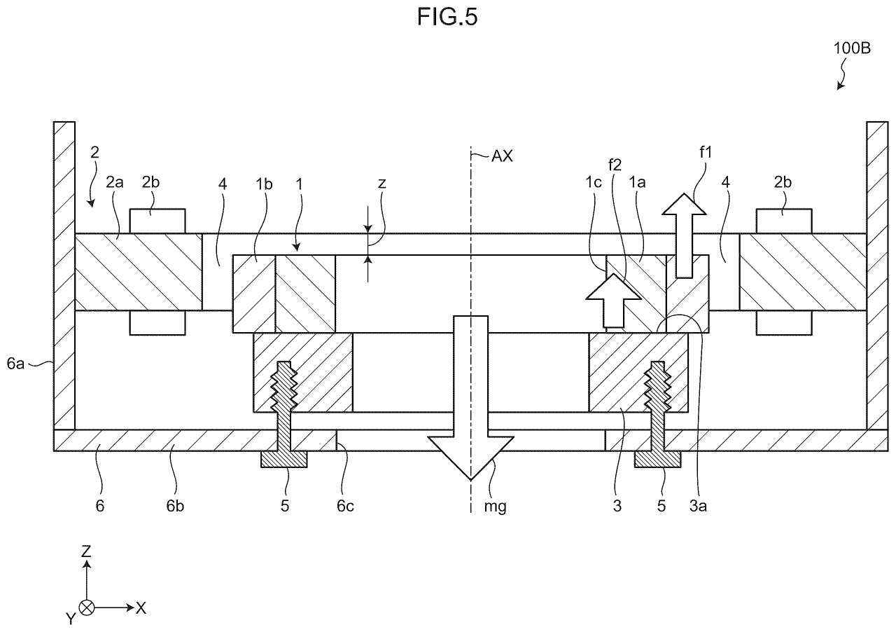

As illustrated in FIG. 5, a rotating machine 100B may include adjustment members 5 with which the position of the support member 3 in the axial direction can be adjusted. FIG. 5 is a cross-sectional view illustrating a configuration of the rotating machine 100B according to a second modification of the first embodiment. FIG. 5 illustrates a frame 6. The frame 6 has a tubular shape open at both ends in the axial direction. The frame 6 includes a peripheral wall 6a and an axial end wall 6b. The peripheral wall 6a is a tubular portion extending in the circumferential direction. One axial end of the peripheral wall 6a is open. The other axial end of the peripheral wall 6a is blocked by the axial end wall 6b. A hole 6c into which a shaft (not illustrated) is inserted is formed in the axial end wall 6b.

The stator 2 is fitted and fixed to the inner peripheral surface of the peripheral wall 6a of the frame 6. The support member 3 is fixed to the axial end wall 6b of the frame 6 via the adjustment members 5. The adjustment members 5 are, for example, screws. The adjustment members 5 pass through the axial end wall 6b in the axial direction from the outer surface to the inner surface of the axial end wall 6b of the frame 6. Distal end portions of the adjustment members 5 are inserted into the support member 3. The position of the support member 3 in the axial direction is changed by turning the screws as the adjustment members 5.

In the present modification, the position of the support member 3 in the axial direction can be adjusted by turning the screws as the adjustment members 5. Thus, the position at which the support member 3 supports the rotor 1, that is, the axial displacement z of the rotor 1 can be adjusted. Consequently, the ratio between the restoring force f1 and the supporting force f2 can be easily changed. For example, the value of the supporting force f2 can be changed to the minimum value in the range of values in which the supporting force f2 is unlikely to cause the vibration of the rotor 1 in the axial direction and the tilt directions. Further, in the case where a load such as a fan or a pump is attached to the rotor 1 and the gravitational force mg on the entire rotor 1 changes, or the case where a reaction force acts on the rotor 1 when fluid is fed from the load such as a fan or a pump, the present modification can quickly and easily change the ratio of the restoring force f1 and the supporting force f2 without disassembling or replacing the entire rotating machine 100B. This can prevent the generation of vibration of the rotor 1 due to a change in the gravitational force mg on the entire rotor 1 or a reaction force acting on the rotor 1, to rotate the rotor 1. The adjustment members 5 may be omitted.

### Second Embodiment

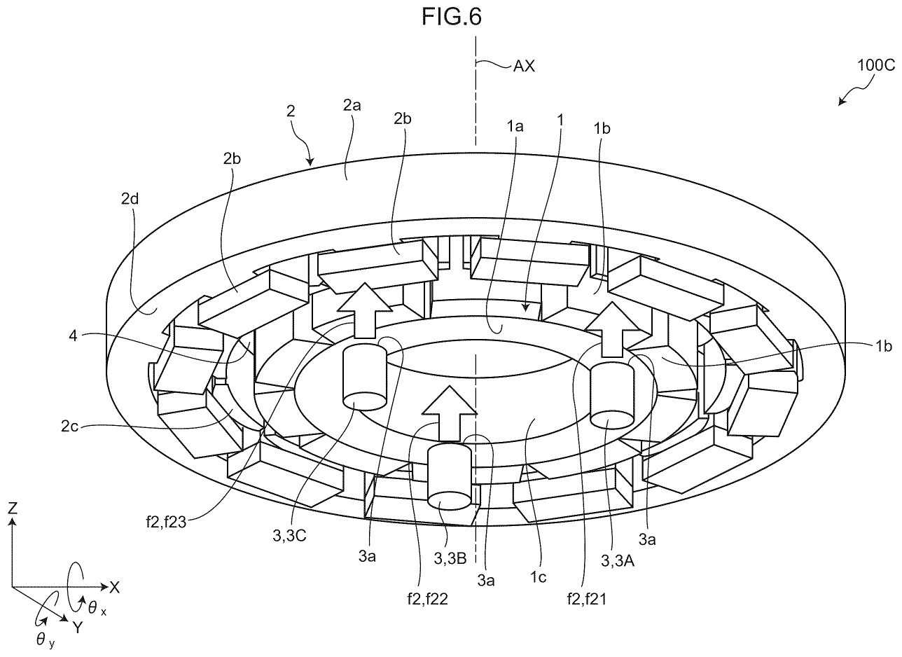

Next, a rotating machine 100C according to a second embodiment will be described with reference to FIG. 6. FIG. 6 is a perspective view illustrating a configuration of the rotating machine 100C according to the second embodiment. The present embodiment is different from the first embodiment in that the rotating machine 100C includes a plurality of the support members 3. In the second embodiment, the same reference numerals are assigned to parts corresponding to those in the first embodiment to omit descriptions. FIG. 6 illustrates a state in which the rotating machine 100C is viewed from one side in the axial direction to facilitate understanding.

The rotating machine 100C includes three support members 3. The support members 3 have a cylindrical shape in the present embodiment, but are not limited to a particular shape as long as the support members 3 can support the rotor 1. Hereinafter, the three support members 3 are referred to as a support member 3A, a support member 3B, and a support member 3C when distinguished from each other. The three support members 3A, 3B, and 3C are disposed apart from each other in the circumferential direction. The three support members 3A, 3B, and 3C are disposed at equal angles in the circumferential direction. The three support members 3A, 3B, and 3C are disposed at intervals of 120 degrees in the circumferential direction. Each of the three support members 3A, 3B, and 3C supports the rotor 1. In other words, the rotor 1 is supported by the three support members 3A, 3B, and 3C spaced apart from each other in the circumferential direction.

Next, effects of the rotating machine 100C according to the present embodiment will be described.

In the present embodiment, the rotor 1 is supported by the three support members 3A, 3B, and 3C spaced apart from each other in the circumferential direction. With this configuration, in the present embodiment, supporting forces f21, f22, and f23 that are forces with which the rotor 1 is supported by the support members 3A, 3B, and 3C, respectively, in the axial direction and the tilt directions are generated at the three support members 3A, 3B, and 3C, respectively. This prevents a further displacement of the rotor 1 in the axial direction and displacements of the rotor 1 in the tilt directions. Consequently, the vibration of the rotor 1 in the axial direction and the tilt directions can be prevented. The points of application of the supporting forces f21, f22, and f23 are preferably positioned at equal angles in the circumferential direction, and are positioned at intervals of 120 degrees in the circumferential direction in the present embodiment. This can further prevent a further displacement of the rotor 1 in the axial direction and displacements of the rotor 1 in the tilt directions.

In the present embodiment, as in the first embodiment, the rotor 1 is displaced vertically downward relative to the stator 2, and the rotor 1 is supported by the support members 3 at a position sunk vertically downward relative to the stator 2. Therefore, the force supporting the gravitational force mg acting on the rotor 1 is the sum of the restoring force f1, which is the force with which the stator 2 magnetically attracts the rotor 1, and the supporting force f2 that is the sum of the supporting forces f21, f22, and f23, which are the forces with which the rotor 1 is axially supported by the support members 3A, 3B, and 3C, respectively. The supporting forces f21, f22, and f23 are equal to the remaining component of the gravitational force mg left unsupported by the restoring force f1, and thus formula (3) below holds.

$$f 21 + f 22 + f 23 = mg - f 1 \qquad ( 3 )$$

Therefore, according to formula (3) above, the restoring force f1 can be increased by setting the axial displacement z of the rotor 1 relative to the stator 2 to a negative value and increasing the absolute value thereof, so that the supporting force f2 can be reduced. This can achieve the same effects as the effects when the supporting force f2 is reduced as described in paragraph 0036 above.

In the present embodiment, the rotor 1 is supported by the three support members 3A, 3B, and 3C spaced apart from each other in the circumferential direction. This configuration allows reductions in the size and weight of the support members 3A, 3B, and 3C as compared with the case of using the single support member 3. If a defect has occurred in any of the three support members 3A, 3B, and 3C, only the one in which the defect has occurred needs to be replaced, so that the cost of replacement can be reduced.

Next, a modification of the second embodiment will be described.

In the present embodiment, the number of the support members 3 is three, but may be four or more. That is, it is sufficient that the rotor 1 of the present embodiment is supported by the three or more support members 3 spaced apart from each other in the circumferential direction. If the positions of the support members 3 vary in the axial direction, for example, a phenomenon may occur in which three of the four or more support members 3 support the rotor 1 and the remaining one or more support members 3 do not support the rotor 1. Even if any of the support members 3 supporting the rotor 1 loses its support function due to wear or chipping, of the four or more support members 3, three or more support members 3 including a support member 3 that has not supported the rotor 1 newly support the rotor 1. This can provide the redundancy of the support members 3 to increase the reliability of the rotating machine 100C.

As in the first embodiment, the three support members 3A, 3B, and 3C may each include a low-friction portion that reduces the frictional force between the support members 3A, 3B, and 3C and the rotor 1. This can reduce the frictional force generated between the rotor 1 and the support members 3 to achieve the same effects as the effects when the supporting force f2 is reduced as described in paragraph 0036 above.

### Third Embodiment

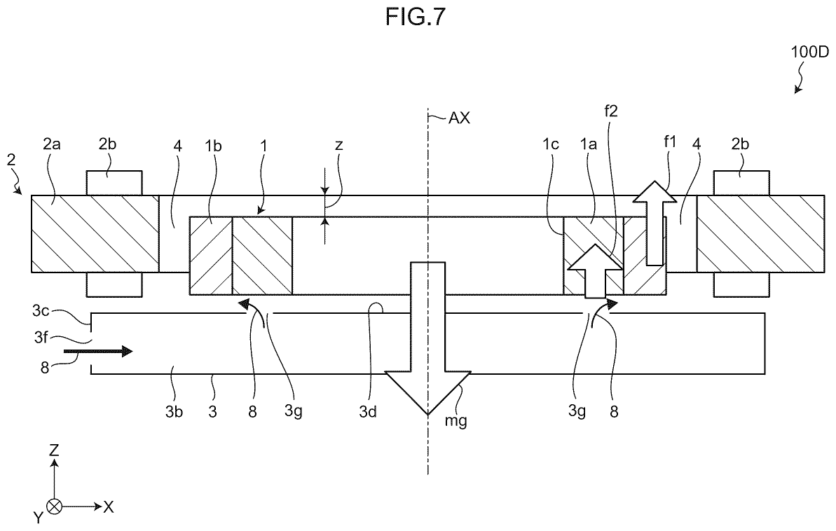

Next, a rotating machine 100D according to a third embodiment will be described with reference to FIG. 7. FIG. 7 is a cross-sectional view illustrating a configuration of the rotating machine 100D according to the third embodiment. The present embodiment is different from the first and second embodiments in that the support member 3 functions as a hydrostatic bearing to support the rotor 1. In the third embodiment, the same reference numerals are assigned to parts corresponding to those in the first and second embodiments to omit descriptions.

The support member 3 is a single member. A flow path 3b through which fluid flows is formed in the support member 3. Reference numeral 8 in FIG. 7 schematically indicates the flow of the fluid. The fluid may be gas or liquid. An example of the gas is air. Examples of the liquid include water and oil. The support member 3 has, for example, a hollow disk shape, but is not limited to a particular shape as long as the fluid is allowed to flow out toward the rotor 1. In the outer peripheral surface 3c of the support member 3, an inlet 3f to allow the fluid to flow into the flow path 3b is formed. In a surface 3d of the support member 3 facing the rotor 1, an outlet 3g to allow the fluid to flow out from the flow path 3b toward the rotor 1 is formed. The outlet 3g has a circumferential shape extending in the circumferential direction. The fluid flowing out through the outlet 3g toward the rotor 1 supports the rotor 1 in the axial direction and the tilt directions. The fluid flowing out through the outlet 3g toward the rotor 1 circumferentially supports the rotor 1. In other words, the fluid flowing out through the outlet 3g toward the rotor 1 supports the rotor 1 over the entire circumference of the rotor 1. In the present embodiment, the support member 3 functions as a hydrostatic bearing to support the rotor 1.

Next, effects of the rotating machine 100D according to the present embodiment will be described.

In the present embodiment, the flow path 3b through which the fluid flows is formed in the support member 3, and the outlet 3g to allow the fluid to flow out from the flow path 3b toward the rotor 1 is formed in the surface 3d of the support member 3 facing the rotor 1. This configuration prevents a further displacement of the rotor 1 in the axial direction and displacements of the rotor 1 in the tilt directions. Consequently, the vibration of the rotor 1 in the axial direction and the tilt directions can be prevented. With the above configuration, the support member 3 functions as the hydrostatic bearing to support the rotor 1, and thus can further reduce the frictional force generated between the rotor 1 and the support member 3.

In the present embodiment, the rotor 1 is displaced vertically downward relative to the stator 2, and the rotor 1 is supported by the support member 3 at a position sunk vertically downward relative to the stator 2. With this configuration, the restoring force f1 can be generated by the axial displacement z of the rotor 1 to reduce the supporting force f2. Consequently, the flow rate and the pressure of the fluid flowing out through the outlet 3g toward the rotor 1 can be reduced. Therefore, it is possible to reduce input energy for preparing the fluid to be allowed to flow into the flow path 3b in the support member 3 through the inlet 3f, and reduce the loss of torque caused by physical contact between the rotor 1 and the support member 3.

Next, a modification of the third embodiment will be described.

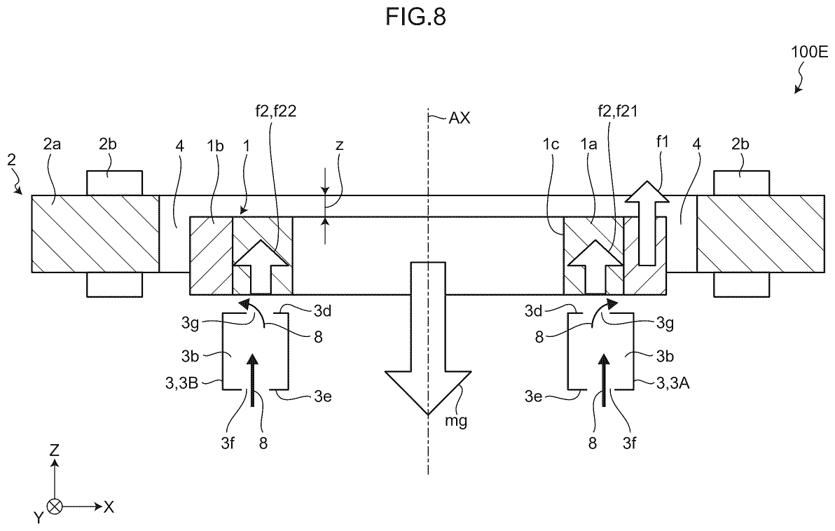

As illustrated in FIG. 8, a rotating machine 100E may include a plurality of the support members 3. FIG. 8 is a cross-sectional view illustrating a configuration of the rotating machine 100E according to the modification of the third embodiment. Although two support members 3 are illustrated in FIG. 8, the rotating machine 100E actually includes three support members 3. FIG. 8 illustrates supporting forces f21 and f22 that are forces with which the rotor 1 is supported by the two support members 3A and 3B, respectively, in the axial direction and the tilt directions. Actually, a supporting force f23 (not illustrated) with which the rotor 1 is supported by the remaining support member 3 (not illustrated) in the axial direction and the tilt directions is also generated. The three support members 3 are disposed apart from each other in the circumferential direction. The three support members 3 are disposed at equal angles in the circumferential direction. The three support members 3 are disposed at intervals of 120 degrees in the circumferential direction.

The flow path 3b through which fluid flows is formed in each of the three support members 3. The support members 3 have, for example, a hollow cylindrical shape, but are not limited to a particular shape as long as the fluid is allowed to flow out toward the rotor 1. In a surface 3e of each support member 3 facing the opposite direction to the rotor 1, the inlet 3f to allow the fluid to flow into the flow path 3b is formed. In the surface 3d of each support member 3 facing the rotor 1, the outlet 3g to allow the fluid to flow out from the flow path 3b toward the rotor 1 is formed. The fluid flowing out through the respective outlets 3g of the three support members 3 toward the rotor 1 supports the rotor 1 in the axial direction and the tilt directions. The fluid flowing out through the respective outlets 3g of the three support members 3 toward the rotor 1 supports the rotor 1 at discrete points. In other words, the rotor 1 is supported by the fluid flowing out through the respective outlets 3g of the three support members 3 spaced apart from each other in the circumferential direction. Also in the present modification, each support member 3 functions as a hydrostatic bearing to support the rotor 1.

The present modification can also achieve the same effects as those of the third embodiment. In the present modification, the number of the support members 3 is three, but may be four or more. That is, it is sufficient that the rotor 1 of the present modification is supported by the fluid flowing out through the respective outlets 3g of the three or more support members 3 spaced apart from each other in the circumferential direction.

### Fourth Embodiment

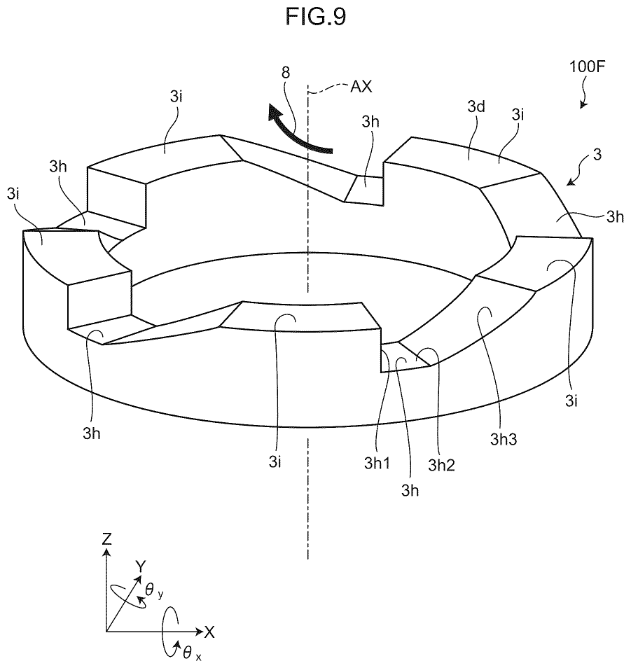

Next, a rotating machine 100F according to a fourth embodiment will be described with reference to FIG. 9. FIG. 9 is a perspective view illustrating a configuration of the support member 3 of the rotating machine 100F according to the fourth embodiment. The present embodiment is different from the first embodiment in that the support member 3 functions as a hydrodynamic bearing to support the rotor 1. In the fourth embodiment, the same reference numerals are assigned to parts corresponding to those in the first embodiment to omit descriptions.

On the surface 3d of the support member 3 facing the rotor 1 (not illustrated), a plurality of grooves 3h open toward the rotor 1 are formed. The plurality of grooves 3h are disposed apart from each other in the circumferential direction. The plurality of grooves 3h are disposed at equal angles in the circumferential direction. The number of the grooves 3h is five in the present embodiment, but is not limited to a particular number. The grooves 3h are recessed in the direction opposite to the direction in which the rotor 1 is located in the axial direction. Flat portions 3i are formed between the grooves 3h adjacent to each other in the circumferential direction. The flat portions 3i are flat portions perpendicular to the axial direction. The flat portions 3i are disposed at positions closer to the rotor 1 than the grooves 3h in the axial direction. The grooves 3h and the flat portions 3i are alternately disposed in the circumferential direction.

Each groove 3h includes a first groove surface 3h1, a second groove surface 3h2, and a third groove surface 3h3. The first groove surface 3h1 is a surface extending in the axial direction. The first groove surface 3h1 is continuous with one of the two flat portions 3i adjacent to the groove 3h. The first groove surface 3h1 extends in the axial direction away from the one flat portion 3i. The second groove surface 3h2 is a surface extending in the circumferential direction. The second groove surface 3h2 extends in the circumferential direction from the end of the first groove surface 3h1 opposite the end continuous with the one flat portion 3i. The third groove surface 3h3 is an inclined surface that is inclined to approach the rotor 1 as the third groove surface 3h3 extends in the circumferential direction away from the second groove surface 3h2. The third groove surface 3h3 is inclined with respect to the axial direction. The third groove surface 3h3 extends in the circumferential direction from the end of the second groove surface 3h2 opposite the end continuous with the first groove surface 3h1. The end of the third groove surface 3h3 opposite the end continuous with the second groove surface 3h2 is continuous with the other of the two flat portions 3i adjacent to the groove 3h.

Next, effects of the rotating machine 100F according to the present embodiment will be described.

In the present embodiment, the grooves 3h open toward the rotor 1 are formed on the surface 3d of the support member 3 facing the rotor 1. With this configuration, when the rotor 1 rotates, the grooves 3h eliminate the passage of the fluid, and the fluid flows from the support member 3 toward the rotor 1. Thus, the pressure of the fluid flowing from the support member 3 toward the rotor 1 is generated. This allows the rotor 1 to rotate without physical contact with the support member 3. Consequently, frictional heat generated between the rotor 1 and the support member 3 can be further reduced, and the loss of torque caused by physical contact between the rotor 1 and the support member 3 can be reduced. As illustrated in FIG. 9, the grooves 3h preferably include the third groove surfaces 3h3 that are inclined surfaces inclined with respect to the axial direction. With this, when the rotor 1 rotates, the inclinations of the three-dimensional grooves 3h eliminate the passage of the fluid, facilitating the flow of the fluid from the support member 3 toward the rotor 1.

A phenomenon in which the rotor 1 is no longer in physical contact with the support member 3 occurs when the rotor 1 rotates. Thus, when the rotor 1 is stationary, the support member 3 does not function as the hydrodynamic bearing to support the rotor 1. However, when the rotation speed of the rotor 1 exceeds a certain threshold value during rotation of the rotor 1, the support member 3 functions as the hydrodynamic bearing to support the rotor 1.

In the present embodiment, part of the gravitational force mg acting on the rotor 1 is supported by the restoring force f1, and thus only the rest of the gravitational force mg on the rotor 1 needs to be supported by the pressure of the fluid flowing from the support member 3 toward the rotor 1. Thus, the supporting force £2 can be reduced. Consequently, the threshold value of the rotation speed of the rotor 1 at which the rotor 1 is no longer in physical contact with the support member 3 can be set low, and the support member 3 functions as the hydrodynamic bearing to support the rotor 1 in a wide operating range of the rotating machine 100F.

The present embodiment also allows a design to reduce the inclination of the three-dimensional grooves 3h to reduce the pressure of the fluid flowing from the support member 3 toward the rotor 1. This can reduce fluid input energy, and thus can increase the operating efficiency of the entire rotating machine 100F.

Next, a modification of the fourth embodiment will be described.

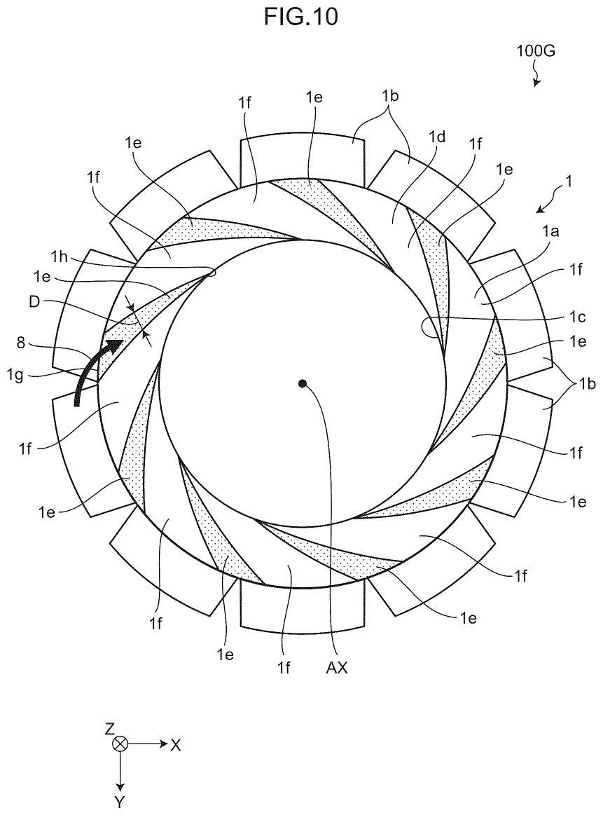

As illustrated in FIG. 10, a plurality of grooves 1e may be formed on the rotor 1. FIG. 10 is a diagram illustrating a configuration of the rotor 1 of a rotating machine 100G according to the modification of the fourth embodiment, and is a diagram when the rotor 1 is viewed in the axial direction. In FIG. 10, the grooves 1e are dot-hatched to facilitate understanding. The plurality of grooves 1e open toward the support member 3 (not illustrated) are formed on a surface 1d of the rotor 1 facing the support member 3. The plurality of grooves 1e are disposed apart from each other in the circumferential direction. The plurality of grooves 1e are disposed at equal angles in the circumferential direction. The number of the grooves 1e is nine in the present embodiment, but is not limited to a particular number. The grooves 1e are recessed in the direction opposite to the direction in which the support member 3 is located in the axial direction. Flat portions 1f are formed between the grooves 1e adjacent to each other in the circumferential direction. The flat portions 1f are flat portions perpendicular to the axial direction. The flat portions 1f are disposed at positions closer to the support member 3 than the grooves 1e in the axial direction. The grooves 1e and the flat portions 1f are alternately disposed in the circumferential direction.

Each groove 1e extends in the radial direction and is formed from the outer peripheral surface to the inner peripheral surface of the rotor 1. Each groove 1e extends in a curve from the outside toward the inside in the radial direction so as to be located on one side in the circumferential direction. When the extending direction of each groove 1e is projected on a plane normal to the rotation axis AX of the rotor 1, the extending direction of each groove 1e is disposed at a position offset from the rotation axis AX of the rotor 1. Openings 1g of the grooves 1e open to the outer peripheral surface of the rotor 1 are disposed apart from each other at equal angles in the circumferential direction. Openings 1h of the grooves 1e open to the inner peripheral surface of the rotor 1 are disposed apart from each other at equal angles in the circumferential direction. The opening 1g and the opening 1h of each groove 1e are offset from each other in the circumferential direction. The groove width D of each groove 1e decreases from the outside toward the inside in the radial direction. In other words, the groove width D of each groove 1e becomes wider toward the outside in the radial direction and narrower toward the inside in the radial direction.

In the present modification, when the rotor 1 rotates, fluid flows into the grooves 1e from the outside in the radial direction. As the fluid flows in the groove 1e toward the inside in the radial direction, the fluid has nowhere to go and flows from the rotor 1 toward the support member 3. Consequently, the pressure of the fluid flowing from the rotor 1 toward the support member 3 is generated, and the rotor 1 repels away from the support member 3 in the axial direction. This allows the rotor 1 to rotate without physical contact with the support member 3. Consequently, frictional heat generated between the rotor 1 and the support member 3 can be further reduced, and the loss of torque caused by the support member 3 physically contacting the rotor 1 can be reduced.

A phenomenon in which the rotor 1 is no longer in physical contact with the support member 3 occurs when the rotor 1 rotates. Thus, when the rotor 1 is stationary, the support member 3 does not function as the hydrodynamic bearing to support the rotor 1. However, when the rotation speed of the rotor 1 exceeds a certain threshold value during rotation of the rotor 1, the support member 3 functions as the hydrodynamic bearing to support the rotor 1. Note that the grooves 3h having the same shape as the grooves 1e illustrated in FIG. 10 may be formed on the surface 3d of the support member 3 illustrated in FIG. 9 facing the rotor 1, or the grooves 1e having the same shape as the grooves 3h illustrated in FIG. 9 may be formed on the surface 1d of the rotor 1 illustrated in FIG. 10 facing the support member 3. It is sufficient that on one of the surface 3d of the support member 3 facing the rotor 1 and the surface 1d of the rotor 1 facing the support member 3, the grooves 3h or 1e open toward the other are formed.

### Fifth Embodiment

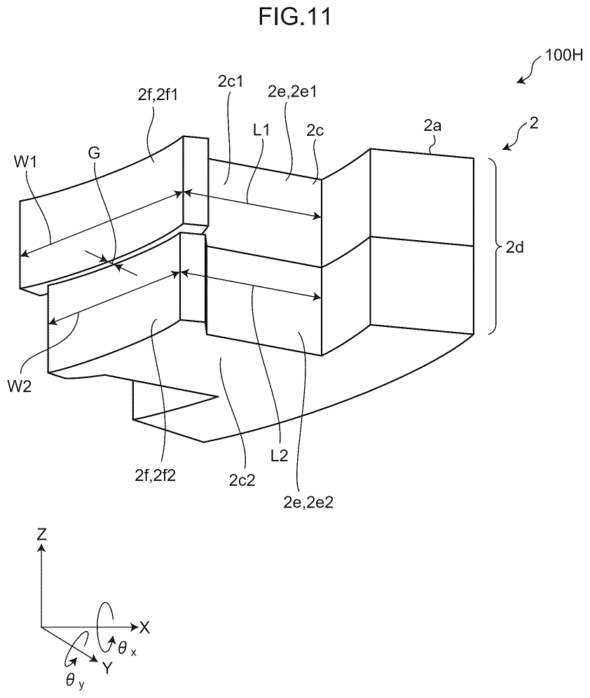

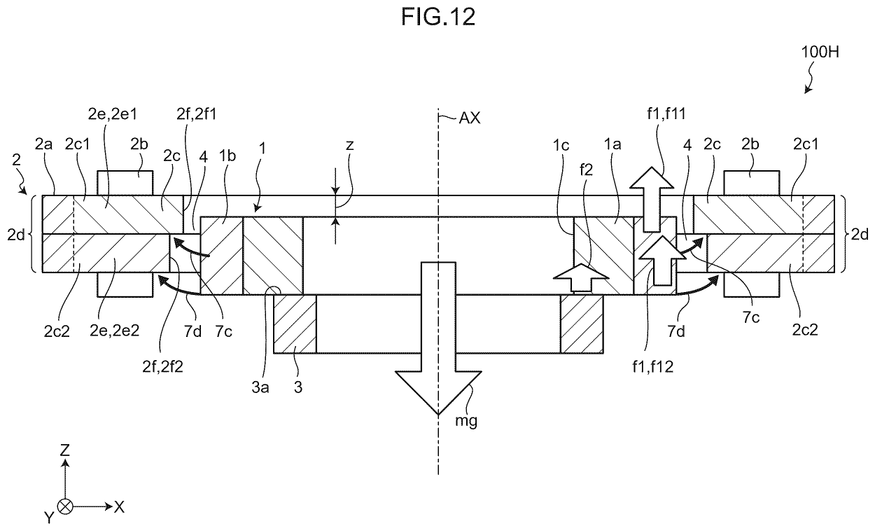

Next, a rotating machine 100H according to a fifth embodiment will be described with reference to FIGS. 11 and 12. FIG. 11 is a perspective view illustrating a configuration of part of the stator core 2a of the rotating machine 100H according to the fifth embodiment. FIG. 12 is a cross-sectional view illustrating a configuration of the rotating machine 100H according to the fifth embodiment, and is a diagram for explaining an axial force acting on the rotor 1. The present embodiment is different from the first embodiment in that permeance decreases in one direction from one side to the other side of the axial direction. In the fifth embodiment, the same reference numerals are assigned to parts corresponding to those in the first embodiment to omit descriptions.

As illustrated in FIGS. 11 and 12, each tooth 2c includes a plurality of tooth body portions 2e projecting radially inward from the back yoke 2d, and a plurality of tooth distal end portions 2f projecting in both circumferential directions from the distal ends of the respective tooth body portions 2e. Each tooth distal end portion 2f has a flange shape with a width wider than the circumferential width of the corresponding tooth body portion 2e. This allows more magnetic fluxes 7c and 7d to pass between the stator 2 and the rotor 1 illustrated in FIG. 12. Broken lines in FIG. 12 schematically indicate the boundary between the teeth 2c and the back yoke 2d.

As illustrated in FIG. 11, the number of the tooth body portions 2e and the number of the tooth distal end portions 2f in each tooth 2c are each two in the present embodiment, but are not limited to a particular number. The two tooth body portions 2e are stacked in the axial direction. The two tooth distal end portions 2f are stacked in the axial direction. Hereinafter, the tooth body portion 2e and the tooth distal end portion 2f disposed on one side in the axial direction are referred to as a first tooth body portion 2e1 and a first tooth distal end portion 2f1, respectively, and the first tooth body portion 2e1 and the first tooth distal end portion 2f1 are collectively referred to as a first tooth portion 2c1. The tooth body portion 2e and the tooth distal end portion 2f disposed on the other side in the axial direction are referred to as a second tooth body portion 2e2 and a second tooth distal end portion 2f2, respectively, and the second tooth body portion 2e2 and the second tooth distal end portion 2f2 are collectively referred to as a second tooth portion 2c2. In the present embodiment, the first tooth portion 2c1 is disposed vertically above the second tooth portion 2c2.

The circumferential width W1 of the first tooth distal end portion 2f1 is wider than the circumferential width W2 of the second tooth distal end portion 2f2. That is, the circumferential width of the tooth distal end portion 2f decreases in one direction from one side in the axial direction on which the first tooth distal end portion 2f1 is located to the other side in the axial direction on which the second tooth distal end portion 2f2 is located. The radial length L1 of the first tooth portion 2c1 is longer than the radial length L2 of the second tooth portion 2c2. That is, the radial length of the tooth 2c decreases in one direction from one side in the axial direction on which the first tooth portion 2c1 is located to the other side in the axial direction on which the second tooth portion 2c2 is located. Thus, in the tooth 2c, a tooth length difference G is produced which is the difference between the radial length L1 of the first tooth portion 2c1 and the radial length L2 of the second tooth portion 2c2.

Here, permeance will be described. Permeance means an amount representing the ease with which the magnetic fluxes 7c and 7d can pass through at least one of the gap 4 or the stator core 2a as the iron core in a magnetic path going around the stator 2 and the rotor 1 along the radial direction and the circumferential direction. In general, since magnetic flux passes through iron more easily than through air, permeance increases when a magnetic path is an iron core. Permeance increases as the width of a magnetic path increases, and increases as the magnetic path length of air decreases and the magnetic path length of an iron core increases. In the present embodiment, the circumferential width W1 of the first tooth distal end portion 2f1 is wider than the circumferential width W2 of the second tooth distal end portion 2f2, and the radial length L1 of the first tooth portion 2c1 is longer than the radial length L2 of the second tooth portion 2c2. Consequently, the permeance is smaller in the second tooth portion 2c2 than in the first tooth portion 2c1. That is, the permeance, which is the amount representing the ease with which the magnetic fluxes 7c and 7d can pass through at least one of the gap 4 or the stator core 2a as the iron core in the magnetic path going around the stator 2 and the rotor 1 along the radial direction and the circumferential direction, decreases in one direction from one side to the other side in the axial direction.

Next, an axial force acting on the rotor 1 will be described. FIG. 12 illustrates a case where the gravitational force mg acts on the rotor 1.

As illustrated in FIG. 12, the force supporting the gravitational force mg acting on the rotor 1 is the sum of the restoring force f1, which is the force with which the stator 2 magnetically attracts the rotor 1, and the supporting force f2, which is the force with which the rotor 1 is supported by the support member 3 in the axial direction. Here, since the rotor 1 is axially displaced relative to the stator 2 by the gravitational force mg, the magnetic flux 7d obliquely passing between the rotor 1 and the lower surfaces of the distal end portions of the second tooth portions 2c2 is generated. Thus, the restoring force f1 includes a restoring force f12 generated by the magnetic flux 7d. Further, due to the difference between the circumferential width W1 of the first tooth distal end portion 2f1 and the circumferential width W2 of the second tooth distal end portion 2f2, and the tooth length difference G illustrated in FIG. 11, the magnetic flux 7c obliquely passing between the rotor 1 and portions of the lower surfaces of the distal end portions of the first tooth portions 2c1 exposed from the second tooth portions 2c2 is also generated. Thus, the restoring force f1 also includes a restoring force f11 generated by the magnetic flux 7c. As a result, the restoring force f1 is generated at a plurality of axial positions in the stator 2, and is the sum of the restoring force f11 and the restoring force f12. Consequently, even when the axial displacement z of the rotor 1 is the same as that in the first embodiment, the restoring force f1 is increased by the amount of the restoring force f11, and the supporting force f2 is reduced by the amount by which the restoring force f1 is increased in the present embodiment, as compared with those in the first embodiment. Thus, formula (4) below holds.

$$f 2 = mg - f 11 - f 12 \qquad ( 4 )$$

Next, effects of the rotating machine 100H according to the present embodiment will be described.

In the present embodiment, the permeance, which is the amount representing the ease with which the magnetic fluxes 7c and 7d can pass through at least one of the gap 4 or the stator core 2a as the iron core in the magnetic path going around the stator 2 and the rotor 1 along the radial direction and the circumferential direction decreases in one direction from one side to the other side in the axial direction. This configuration allows the restoring force f1 to be increased in one direction from the other side to the one side in the axial direction. Consequently, frictional heat generated between the rotor 1 and the support member 3 can be further reduced, and the loss of torque caused by the support member 3 physically contacting the rotor 1 can be reduced. This can further increase the life of the support member 3, and can further increase the operating efficiency of the entire rotating machine 100H.

In the present embodiment, the generation of the restoring force f11 means that the axial displacement z of the rotor 1 can be brought close to zero when the supporting force f2 is constant. As the axial displacement z of the rotor 1 approaches zero, the area where the rotor 1 and the stator 2 face each other in the radial direction increases, and the supporting force in the radial direction (XY axis direction) and the torque increase. Consequently, it is possible to reduce the current necessary for generating the same supporting force in the radial direction (XY axis direction) and the same torque, to increase the operating efficiency of the entire rotating machine 100H.

Next, a modification of the fifth embodiment will be described.

The present embodiment has illustrated the case where the first tooth portion 2c1 and the second tooth portion 2c2 are different in both the circumferential width and the radial length, but the first tooth portion 2c1 and the second tooth portion 2c2 may be different in only one of the circumferential width and the radial length. The present embodiment has illustrated the case where two tooth portions, the first tooth portion 2c1 and the second tooth portion 2c2, are different in both the circumferential width and the radial length, but three or more tooth portions may be different in one of the circumferential width and the radial length.

The support member 3 of the present embodiment may be changed to a configuration to function as a hydrostatic bearing to support the rotor 1 as in the third embodiment, or may be changed to a configuration to function as a hydrodynamic bearing to support the rotor 1 as in the fourth embodiment. In the present embodiment, by increasing the restoring force f1, the pressure of fluid required when the support member 3 functions as a hydrostatic bearing or a hydrodynamic bearing can be further reduced.

The configurations described in the above embodiments illustrate an example and can be combined with another known art. The embodiments can be combined with each other. The configurations can be partly omitted or changed without departing from the gist.

### REFERENCE SIGNS LIST

1 rotor; 1a rotor core; 1b permanent magnet; 1c through hole; 1d, 3d, 3e surface; 1e, 3h groove; 1f, 3i flat portion; 1g, 1h opening; 2 stator; 2a stator core; 2b, 2b1, 2b2 winding; 2c tooth; 2c1 first tooth portion; 2c2 second tooth portion; 2d back yoke; 2e tooth body portion; 2e1 first tooth body portion; 2e2 second tooth body portion; 2f tooth distal end portion; 2f1 first tooth distal end portion; 2f2 second tooth distal end portion; 3, 3A, 3B, 3C support member; 3a support surface; 3b flow path; 3c outer peripheral surface; 3f inlet; 3g outlet; 3h1 first groove surface; 3h2 second groove surface; 3h3 third groove surface; 4 gap; 5 adjustment member; 6 frame; 6a peripheral wall: 6b axial end wall; 6c hole; 7a, 7b, 7c, 7d magnetic flux; 8 flow of fluid; 100, 100A, 100B, 100C, 100D, 100E, 100F, 100G, 100H rotating machine; AX rotation axis.

1. A rotating machine comprising:
a rotor to rotate about a rotation axis;
a stator disposed on an outer periphery or an inner periphery of the rotor with a gap between the stator and the rotor;
a support member disposed on at least one side of the rotor in an axial direction along the rotation axis, to support the rotor so as to limit displacements of the rotor in the axial direction and a tilt direction; and
a frame to house the rotor, the stator, and the support member, wherein
at least one of the rotor or the stator includes an iron core,
at least another of the rotor or the stator includes a magnetic-force generating member,
the iron core and the magnetic-force generating member are disposed such that the rotor displaced in the axial direction and the tilt direction is restored to an equilibrium position by a force with which the stator magnetically attracts the rotor,
the rotor is supported by the support member at a position displaced in the axial direction relative to the stator,
the support member is directly fixed to the frame or indirectly fixed to the frame via another member,
the rotor is passively stable in the axial direction and the tilt direction due to a force with which the stator magnetically attracts the rotor in a non-contact manner, and the support member to support the rotor, and
the rotor is actively stable in a radial direction of the rotor due to a supporting force in the radial direction to support the rotor relative to the stator in a non-contact manner generated by energizing windings on the stator.

2. The rotating machine according to claim 1, wherein
the support member is in circumferential contact with the rotor, and
the support member includes a low-friction portion to reduce a frictional force between the support member and the rotor.

3. The rotating machine according to claim 1, wherein the support member is three or more support members spaced apart from each other in a circumferential direction, and the rotor is supported by the three or more support members.

4. The rotating machine according to claim 1, wherein
the axial direction along the rotation axis is parallel to a vertical direction, and
the support member is disposed below the rotor in the vertical direction.

5. The rotating machine according to claim 1, wherein
when a position of the stator in the axial direction is used as a reference position, the support member supports the rotor at a position at which the rotor is displaced from the reference position in a direction of a gravitational force acting on the rotor or a direction in which a reaction force acting on the rotor rotating is generated in the axial direction, and
a supporting force generated by the support member is reduced by a load borne by a restoring force in the axial direction generated between the stator and the rotor, as compared with a case where the rotor is supported at a position not displaced from the reference position in the axial direction.

6. The rotating machine according to claim 1, comprising an adjustment member with which a position of the support member in the axial direction can be adjusted, wherein
the support member is indirectly fixed to the frame via the adjustment member that is the another member.

7. The rotating machine according to claim 1, wherein
a flow path through which fluid flows is formed in the support member, and
an outlet to allow the fluid to flow out from the flow path toward the rotor is formed in a surface of the support member facing the rotor.

8. The rotating machine according to claim 1, wherein on one of a surface of the support member facing the rotor and a surface of the rotor facing the support member, grooves are formed, the grooves opening toward another of the surface of the support member facing the rotor and the surface of the rotor facing the support member.

9. The rotating machine according to claim 1, wherein permeance that is an amount representing ease with which magnetic flux can pass through at least one of the gap or the iron core in a magnetic path going around the stator and the rotor along a radial direction and a circumferential direction decreases in one direction from one side to an opposite side in the axial direction.

10. A rotating machine comprising:
a rotor to rotate about a rotation axis;
a stator disposed on an outer periphery or an inner periphery of the rotor with a gap between the stator and the rotor;
a support member disposed on at least one side of the rotor in an axial direction along the rotation axis, to support the rotor so as to limit displacements of the rotor in the axial direction and a tilt direction; and
a frame to house the rotor, the stator, and the support member, wherein
at least one of the rotor or the stator includes an iron core,
at least another of the rotor or the stator includes a magnetic-force generating member,
the iron core and the magnetic-force generating member are disposed such that the rotor displaced in the axial direction and the tilt direction is restored to an equilibrium position by a force with which the stator magnetically attracts the rotor,
the rotor is displaced in the axial direction relative to the stator, and is supported by the support member at a position where a surface not facing the stator is provided on only one side in the axial direction of an outer peripheral surface or an inner peripheral surface of the rotor facing the gap,
the support member is directly fixed to the frame or indirectly fixed to the frame via another member,
when a position of the stator in the axial direction is used as a reference position, the support member supports the rotor at a position at which the rotor is displaced from the reference position in a direction of a gravitational force acting on the rotor or a direction in which a reaction force acting on the rotor rotating is generated in the axial direction,
a supporting force generated by the support member is reduced by a load borne by a restoring force in the axial direction magnetically generated between the stator and the rotor in a non-contact manner, as compared with a case where the rotor is supported at a position not displaced from the reference position in the axial direction, and
the rotor is actively stable in a radial direction of the rotor due to a supporting force in the radial direction to support the rotor relative to the stator in a non-contact manner generated by energizing windings on the stator.

11. The rotating machine according to claim 10, wherein
the support member is in circumferential contact with the rotor, and
the support member includes a low-friction portion to reduce a frictional force between the support member and the rotor.

12. The rotating machine according to claim 10, wherein the support member is three or more support members spaced apart from each other in a circumferential direction, and the rotor is supported by the three or more support members.

13. The rotating machine according to claim 10, wherein
the axial direction along the rotation axis is parallel to a vertical direction, and
the support member is disposed below the rotor in the vertical direction.

14. The rotating machine according to claim 10, comprising an adjustment member with which a position of the support member in the axial direction can be adjusted, wherein
the support member is indirectly fixed to the frame via the adjustment member that is the another member.

15. The rotating machine according to claim 10, wherein
a flow path through which fluid flows is formed in the support member, and
an outlet to allow the fluid to flow out from the flow path toward the rotor is formed in a surface of the support member facing the rotor.

16. The rotating machine according to claim 10, wherein on one of a surface of the support member facing the rotor and a surface of the rotor facing the support member, grooves are formed, the grooves opening toward another of the surface of the support member facing the rotor and the surface of the rotor facing the support member.

17. The rotating machine according to claim 10, wherein permeance that is an amount representing ease with which magnetic flux can pass through at least one of the gap or the iron core in a magnetic path going around the stator and the rotor along a radial direction and a circumferential direction decreases in one direction from one side to an opposite side in the axial direction.
